(19) United States
(12) Patent Application Publication
(10) Pub. No.: US 2026/0152102 A1
(43) Pub. Date: Jun. 4, 2026

(54) LUMBAR SHIELD ARRANGEMENT FOR A BACKREST OF A VEHICLE SEAT, VEHICLE SEAT, MOTOR VEHICLE

(71) Applicant: Volkswagen Aktiengesellschaft, Wolfsburg (DE)

(72) Inventors: Johann GIGGEL, Gardelegen (DE); Martin KOSCHE, Gifhorn (DE); Viktor PETKER, Wolfsburg (DE); Ralph BOETTGER, Ebendorf (DE)

(73) Assignee: Volkswagen Aktiengesellschaft, Wolfsburg (DE)

(21) Appl. No.: 19/420,543

(22) Filed: Dec. 15, 2025

Related U.S. Application Data
(63) Continuation of application No. PCT/EP2024/065696, filed on Jun. 7, 2024.

(30) Foreign Application Priority Data
Jun. 14, 2023 (DE) 10 2023 205 548.1

(51) Int. Cl. B60N 2/66

(52) U.S. Cl. CPC B60N 2/665

(57) ABSTRACT

A lumbar shield arrangement for a backrest of a vehicle seat, having a lumbar shield and a support structure that is situated at the lumbar shield and that has at least one support bar for suspending the lumbar shield on the backrest. The support bar has at least one hook-shaped fastening element, in particular with an L-shaped cross section, for non-rotatably attaching a lumbar pad. The fastening element geometrically corresponds to a fastening opening in the lumbar pad.

This nonprovisional application is a continuation of International Application No. PCT/EP2024/065696, which was filed on Jun. 7, 2024, and which claims priority to German Patent Application No. 10 2023 205 548.1, which was filed in Germany on Jun. 14, 2023, and which are both herein incorporated by reference.

### BACKGROUND OF THE INVENTION

### Field of the Invention

The invention relates to a lumbar shield arrangement for a backrest of a vehicle seat, having a lumbar shield, and a support structure that is situated at the lumbar shield and that has at least one support bar for suspending the lumbar shield on the backrest. The invention further relates to a vehicle seat having such a lumbar shield arrangement, and to a vehicle having such a vehicle seat.

### Description of the Background Art

Lumbar shield arrangements of the above-mentioned type are known from the prior art. For example, a lumbar shield that is attached by means of lumbar wires is known from Patent Specification DE 10 2004 050 144 B4, which corresponds to US2006/0103215, which is incorporated herein by reference. These types of lumbar shields are used, for example, for lumbar shield arrangements having a massage function. For example, a seat back part having a lumbar shield is known from Unexamined German Patent Application DE 198 29 831 A1, which is incorporated herein by reference, having a vibrator element as a massage module directly coupled to its rear side. Also known are pneumatic lumbar shield arrangements which allow adjustment of the spinal column support (lordosis) for a user-specific natural contour of the spinal column in the lumbar region (S contour of the spinal column) via filling of air cushions or air pockets which in particular overlap in areas. Air is generally supplied by a pump system. Filling, venting, and maintenance of the air pressure are controlled via control devices and valve assemblies.

### SUMMARY OF THE INVENTION

It is therefore an object of the present invention to provide an improved lumbar shield arrangement, which by means of additional fastening options for further components has a high level of flexibility for proper use of the lumbar shield arrangement.

According to an example of the invention, it is provided that the support bar has at least one hook-shaped fastening element, in particular with an L-shaped cross section, for nonrotatably attaching a lumbar pad, the fastening element geometrically corresponding to a fastening opening in the lumbar pad. Such a fastening element provides a particularly advantageous option for fixing a lumbar pad to the backrest, which manages without additional fastening points at the backrest itself. In addition, as a result of the fastening element being situated at the support bar, not at the lumbar shield, an advantageous modular system is provided in which different lumbar shields and lumbar pads are combinable with one another by simply modifying the support bar. The lumbar pad includes in particular an elastically deformable foam. In particular, as protection the lumbar pad is mounted or mountable on a side (rear side) of the backrest facing away from a user. The support bar is preferably integrated into the lumbar shield, at least in areas, in particular inside the lumbar shield. In particular, the support bar has a meandering design, and has a plurality of sections that are angled relative to one another, with some of the sections, at least in areas, being directly integrated into the lumbar shield. The lumbar shield, at least with regard to its outer contour, has an essentially mirror-symmetrical design with respect to its longitudinal center axis.

The fastening element can have a one-piece design with a casing of the support bar which in particular includes a plastic. Such a design of the fastening element provides a particularly advantageous option for jointly manufacturing the fastening element and the casing, in which in particular no additional production step is needed for manufacturing the fastening element. In particular, the casing is manufactured by extrusion coating of the support bar. The support bar in particular includes a metal.

It is particularly preferably provided that at least two fastening elements can be situated mirror-symmetrically with respect to a longitudinal center axis of the lumbar shield at the or each support bar. Using two such fastening elements advantageously ensures that the lumbar pad is held at the lumbar shield with a secure alignment. In particular, the fastening elements are situated at mutually opposite edge areas of the lumbar pad.

The fastening element can have at least one rear engagement element. The rear engagement element results in the advantage that the lumbar pad may be held in a form-fit manner in multiple dimensions.

The fastening element can have an L-shaped cross section, and that a rear engagement element can be formed on at least one leg of the L shape, in particular on each of the legs. In this way, the lumbar pad is securely held and fixed in its alignment in a particularly advantageous manner. In this regard, the fastening element has a double hook-shaped design, with one of the legs preferably extending at least essentially vertically, and the other leg extending at least essentially horizontally, when properly installed. In particular, at least one of the legs forms a straight line. At least one of the legs particularly preferably can extend in an arched manner, and in particular when properly installed describes an upwardly directed arch. The rear engagement elements are in each case can be situated at an end of the leg facing away from the respective other leg. The rear engagement elements can be situated at the fastening element in such a way that they are associated with oppositely facing directions or have oppositely facing effective directions. At least one of the rear engagement elements can have a run-up slope to simplify suspension of the lumbar pad.

The fastening element can include at least one reinforcing rib. The reinforcing rib results in the advantage that the fastening element has a particularly robust design. The reinforcing rib can be situated at one of the legs, between the respective rear engagement element and the other leg.

The support bar can have a first section, in particular for attaching a seat cover, in particular a knee recess, which at one end is associated with the lumbar shield, and the support bar has a second section that adjoins the first section at the other end and is oriented at an angle, in particular a right angle, with respect to the first section, and that has the fastening element, and at one end has a further fastening element for attachment in or at the backrest. A particularly advantageous option for fastening a further component to the support bar is thus provided, which is still geometrically independent of the fastening element for the lumbar pad. Two first sections with second sections adjoining same are preferably provided, in particular at least the first sections being oriented mirror-symmetrically opposite one another with respect to the longitudinal center axis and in parallel to one another.

The first section can extend at least essentially horizontally when properly installed, and that the second section extends at least essentially vertically when properly installed. This simplifies installation of the lumbar shield as a whole, and of the seat cover thereon, in a particularly advantageous manner.

The lumbar shield can be fiber-reinforced, and in particular includes a fiber-reinforced plastic. The lumbar shield has a particularly advantageously robust design as a result.

At least two gate points for the fibers, in particular glass fibers, can be situated on, or mirror-symmetrically with respect to, a longitudinal center axis of the lumbar shield. The robustness of the lumbar shield is thus advantageously further improved. In particular, four gate points lying on the longitudinal center axis, or two gate points situated mirror-symmetrically with respect to the longitudinal center axis, in particular approximately centrally relative to the longitudinal extension of the lumbar shield, and two gate points situated on the edge side, in particular above and below relative to the longitudinal extension, lying on the longitudinal center axis, are used.

The lumbar shield can have at least one recess and/or a fastening point for a fan assembly. This advantageously ensures that the fan assembly, as a further component, is or can be flexibly situated at or near the lumbar shield. A plurality of fastening points distributed around the recess is preferably provided.

The lumbar shield can have at least one further fastening element, in particular on the edge side, for attaching an air cushion. This advantageously ensures that the air cushion, as a further component, is or can be flexibly mounted on the lumbar shield. A plurality of spaced-apart fastening elements for multiple air cushions is preferably provided to ensure optimized, secure seating of the air cushions. Fastening elements are preferably provided at mutually opposite edge areas of the lumbar shield so that the air cushion completely overlaps the lumbar shield between the edge areas. The air cushions in particular include an elastically deformable film.

The fastening element can have a rotationally symmetrical, in particular spherical, fastening section for the air cushion. This ensures simple installation in a particularly advantageous manner. In particular, a through hole in the air cushion is or may be associated with the fastening section. The diameter of the fastening section is preferably at least minimally larger than the diameter of the through hole, so that the air cushion is held in a form-fit manner.

The vehicle seat for a motor vehicle, can have a backrest and is characterized in that the lumbar shield arrangement according to the invention is situated in or at in particular a seat frame of the backrest. This results in the advantages stated above. The same advantages result when the vehicle seat is used in other means of transportation, in particular aircraft, and also when the lumbar shield arrangement according to the invention is used in seats not installed in means of transportation, for example seat massagers.

The motor vehicle may be characterized by at least one vehicle seat according to the invention, which also results in the advantages stated above. In particular, the motor vehicle has the vehicle seat as a driver's seat.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an exemplary lumbar shield arrangement,

FIG. 2 shows the lumbar shield arrangement mounted in a backrest,

FIGS. 3A and 3B show detailed views of the lumbar shield arrangement,

FIGS. 4A and 4B show further detailed views of the lumbar shield arrangement, and

FIG. 5 shows a further detailed view of the lumbar shield arrangement.

### DETAILED DESCRIPTION

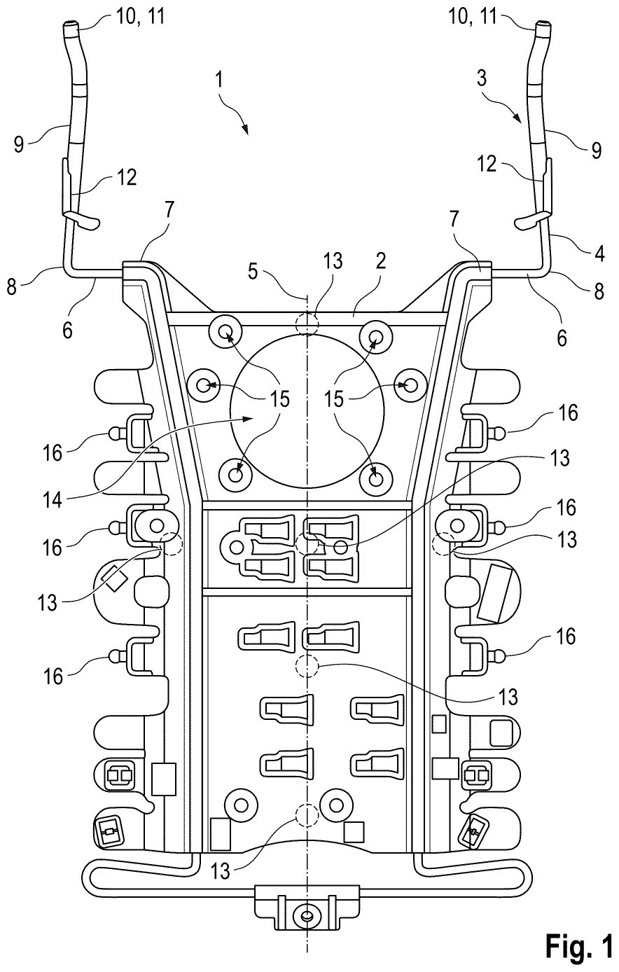

FIG. 1 shows an advantageous lumbar shield arrangement 1 for a backrest, in the present case, of a vehicle seat. The lumbar shield arrangement 1 includes a lumbar shield 2. The lumbar shield 2 is illustrated in a top view on a first side surface. A support structure 3 is situated at the lumbar shield 2. The support structure 3 has a support bar 4 for suspending the lumbar shield 2 on the backrest. The lumbar shield 2, at least with regard to its outer contour, has an essentially mirror-symmetrical design with respect to its longitudinal center axis 5. The support bar 4 also has a mirror-symmetrical design with respect to the longitudinal center axis 5, and is situated in or at the lumbar shield 2.

The support bar 4 bar has a meandering design, and in the present case has a plurality of sections that are angled relative to one another, with some of the sections, at least in areas as is apparent in FIG. 1, being directly integrated into the lumbar shield 2 or extending inside the lumbar shield 2. It is particularly relevant for the present invention that two first sections 6, which are oriented mirror-symmetrically opposite one another with respect to the longitudinal center axis 5 and in parallel to one another, with a first end 7 are each associated with the lumbar shield 2 and extend inside the lumbar shield 2. In the present case the first sections 6 are designed as attachment sections for a seat cover, and for this purpose extend at least essentially horizontally when properly installed.

Adjoining a second end 8 of the respective first section 6, the support bar 4 in each case has second sections 9, likewise relevant, which are angled, in the present case at at least approximately right angles, relative to the respective first section 6. Correspondingly, the second sections 9, at least with the backrest upright, extend at least essentially vertically when properly installed.

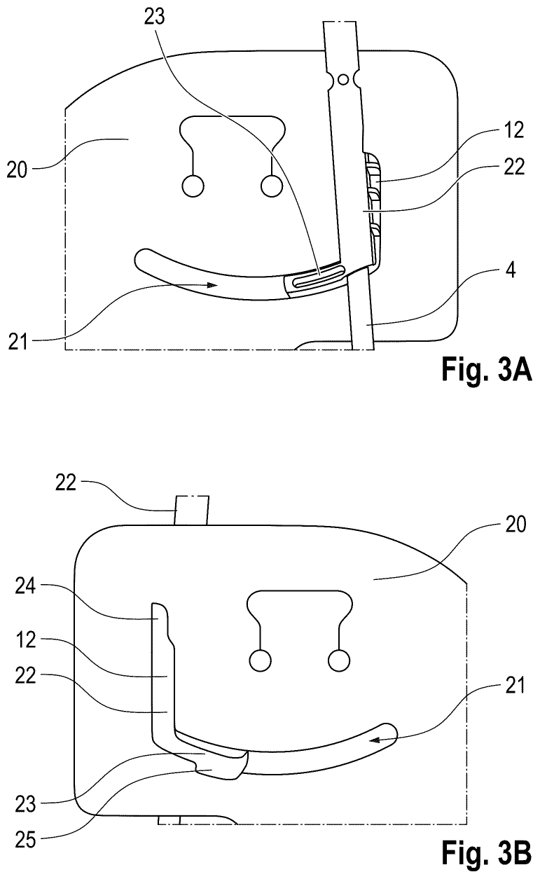

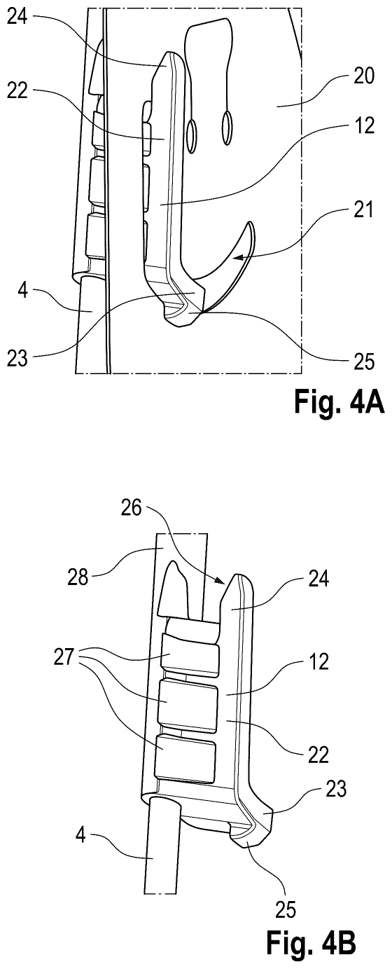

At a third end 10 of the respective second section 9, facing away from the second end 8, and which in each case is an end of the support bar 4 as a whole, each of the second sections 9 has a first fastening element 11 for attachment in or to the backrest. A second fastening element 12 for nonrotatably attaching a lumbar pad is situated in each case at the second section 9, between the two ends 8, 10. Two fastening elements 12 are situated mirror-symmetrically with respect to the longitudinal center axis 5 of the lumbar shield 2, at the same support bar 4. The fastening elements 12 are described in greater detail below with reference to FIGS. 3A through 4B.

The lumbar shield 2 in the present case is fiber-reinforced, and in particular includes a fiber-reinforced plastic. At least two gate points 13 for providing the fibers, in particular glass fibers, on the end side in each case are situated on or mirror-symmetrically with respect to the longitudinal center axis 5 of the lumbar shield 2. A total of six gate points 13 are indicated by way of example, namely, four lying on the longitudinal center axis 5 and two situated mirror-symmetrically with respect to the longitudinal center axis 5. In particular, the four gate points 13 lying on the longitudinal center axis 5, or the two gate points 13 situated mirror-symmetrically with respect to the longitudinal center axis (approximately centrally relative to the longitudinal extension) and the two gate points 13 situated on the edge side (above and below relative to the longitudinal extension), are used.

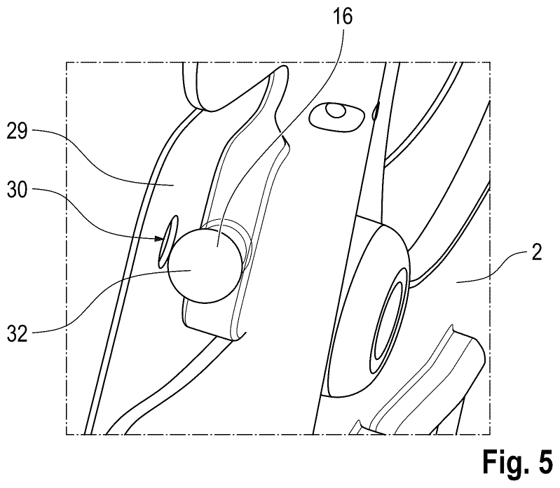

In addition, the lumbar shield 2 has a recess 14, which in the present case is circular, and a plurality of, in the present case six, fastening points 15 designed as through holes and distributed around the recess 14, for a fan assembly. Alternatively, installation space for the fan assembly is provided between the sections 9 by the above-described arrangement of the sections 6, 9. Lastly, the lumbar shield 2 includes a plurality of, in the present case six, third fastening elements 16 on the edge side for attaching air cushions. The fastening elements 16 are described in greater detail with reference to FIG. 5.

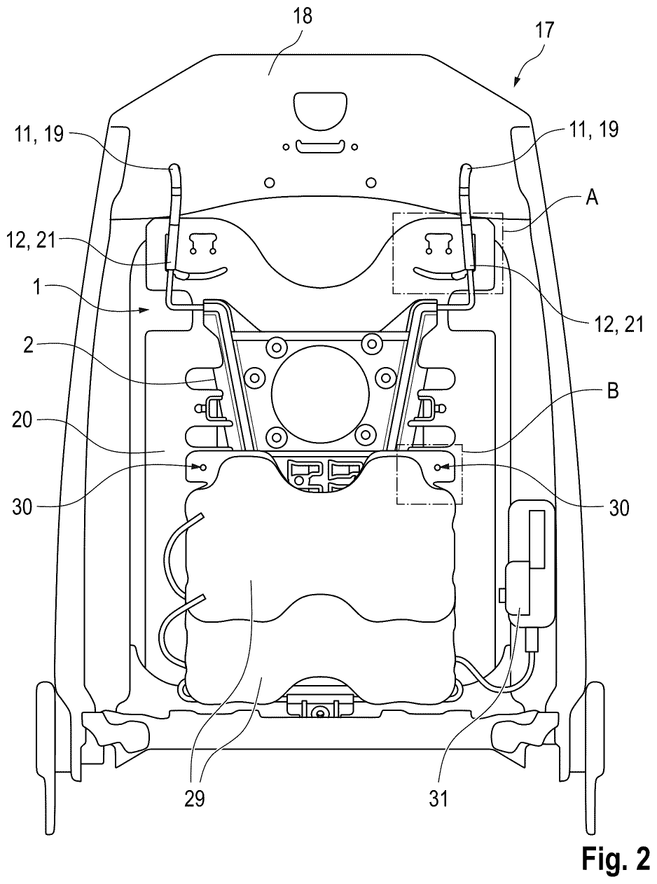

FIG. 2 illustrates the lumbar shield arrangement 1 properly mounted in a backrest 17 or in a seat frame 18 of the backrest 17. The lumbar shield 2 is suspended in the seat frame 18, by means of the fastening elements 11, in recesses 19 that geometrically correspond to the fastening elements. The lumbar shield 2 is illustrated in a top view on a second side surface facing away from the first side surface. An in particular textile lumbar pad 20 is suspended on the fastening elements 12.

The functioning of this suspension is now described with reference to FIGS. 3A through 4B. FIG. 3A illustrates an enlarged detail A from FIG. 2, and FIG. 3B illustrates the same detail from the perspective of FIG. 1, i.e., as a top view of the first side surface of the lumbar shield 2, or in other words, a front view and a rear view, respectively, of the detail in question. It is apparent in each case that the fastening element 12 in cross section has an at least essentially L-shaped design or has an L-shaped cross section, and geometrically corresponds to a fastening opening 21 in the lumbar pad 20.

On account of the L shape, the fastening element 12 has a first leg 22 and a second leg 23 connected thereto. When properly installed as illustrated, the first leg 22 extends essentially vertically, and the second leg 23 extends at least essentially horizontally, wherein in the present case the second leg 23, unlike the first leg 22, does not form a straight line and instead extends in an arched manner, and in particular describes an upwardly directed arch. A first rear engagement element 24 is situated at the first leg 22, in the present case at the end of the first leg 22 facing away from the second leg 23, and a second rear engagement element 25 is situated at the second leg 23, in the present case at the end of the second leg 23 facing away from the first leg 22, so that the fastening element 12 as a whole also has a double hook shape.

The design and function of the rear engagement elements 24, 25 are shown in greater detail in FIGS. 4A and 4B, each of which illustrates a three-dimensional view of detail A as in FIG. 3B, with the lumbar pad 20 in FIG. 4A and without the lumbar pad 20 in FIG. 4B. The rear engagement elements 24, 25 are situated at the fastening element 12 in such a way that they are associated with mutually opposite directions or act in mutually opposite directions, in the present case with the first rear engagement element 24 at the top and the second rear engagement element 25 at the bottom.

During attachment in the fastening element 12, the lumbar pad 20 with the fastening opening 21 is elastically deformed and pulled over both rear engagement elements 24, 25 so that it is securely held. It is apparent that the first rear engagement element 24 has a run-up slope 26 to simplify the suspension of the lumbar pad 20. It is also apparent that the fastening element 12 has multiple, in the present case at least three, reinforcing ribs 27 to increase the stability. The reinforcing ribs 27 are situated at the first leg 22, between the rear engagement element 24 and the second leg 23. It is clearly apparent in particular in FIG. 4B that the fastening element 12 has a one-piece design with a casing 28 of the support bar 4 which in particular includes a plastic.

As explained above with reference to FIG. 1, in addition to the fastening elements 12 the lumbar shield 2 also includes the fastening elements 16 for air cushions. FIG. 2 illustrates two overlapping air cushions 29, in particular as an integral part of a massage function, each having at two oppositely situated corners a through hole 30 for one of the fastening elements 16. Two fastening elements 16 situated oppositely with respect to the longitudinal center axis 5, i.e., at mutually opposite edge areas of the lumbar shield 2, are or may be associated with each air cushion 29, so that a total of three air cushions 29, each of which completely overlaps the lumbar shield 2 between the edge areas, are or may be fastened to the lumbar shield 2. The air cushions 29 are each connected or connectable to a pneumatic pump system 31 via lines.

Lastly, FIG. 5 illustrates a detail B from FIG. 2 in a three-dimensional view from the perspective of FIG. 1, analogously to FIGS. 4A and 4B. It is apparent that the fastening element 16 has a fastening section 32 that is rotationally symmetrical, in the present case at least approximately spherical, onto which the air cushion 29 may be fitted via the through hole 30 by folding over the respective corner toward the fastening section 32 and elastically deforming the through hole 30. The diameter of the fastening section 32 is at least minimally larger than the diameter of the through hole 30, so that the air cushion 29.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A lumbar shield arrangement for a backrest of a vehicle seat, the lumbar shield arrangement comprising:
a lumbar shield;
a support structure that is arranged at the lumbar shield;
at least one support bar to suspend the lumbar shield on the backrest, the at least one support bar having at least one hook-shaped fastening element with an L-shaped cross section, for non-rotatably attaching a lumbar pad, the fastening element geometrically corresponding to a fastening opening in the lumbar pad.

2. The lumbar shield arrangement according to claim 1, wherein the fastening element has a one-piece design with a casing of the support bar which includes a plastic.

3. The lumbar shield arrangement according to claim 1, wherein at least two fastening elements are arranged mirror-symmetrically with respect to a longitudinal center axis of the lumbar shield at the or each support bar.

4. The lumbar shield arrangement according to claim 1, wherein the fastening element includes at least one rear engagement element.

5. The lumbar shield arrangement according to claim 1, wherein the fastening element has an L-shaped cross section, and wherein a rear engagement element is formed on at least one leg of the L shape or on each of the legs.

6. The lumbar shield arrangement according to claim 1, wherein the fastening element includes at least one reinforcing rib.

7. The lumbar shield arrangement according to claim 1, wherein the support bar has a first section to attach a seat cover or a knee recess, which at one end is associated with the lumbar shield, and wherein the support bar has a second section that adjoins the first section at the other end and is oriented at an angle or a right angle with respect to the first section, and has the fastening element and at one end has a further fastening element for attachment in or at the backrest.

8. The lumbar shield arrangement according to claim 7, wherein the first section extends at least essentially horizontally when properly installed, and wherein the second section extends at least essentially vertically when properly installed.

9. The lumbar shield arrangement according to claim 1, wherein the lumbar shield is fiber-reinforced, and includes a fiber-reinforced plastic.

10. The lumbar shield arrangement according to claim 9, wherein at least two gate points for the fibers or glass fibers are arranged on, or mirror-symmetrically with respect to, a longitudinal center axis of the lumbar shield.

11. The lumbar shield arrangement according to claim 1, wherein the lumbar shield has at least one recess and/or a fastening point for a fan assembly.

12. The lumbar shield arrangement according to claim 1, wherein the lumbar shield has at least one further fastening element on the edge side to attach an air cushion.

13. The lumbar shield arrangement according to claim 12, wherein the fastening element has a rotationally symmetrical or spherical fastening section for the air cushion.

14. A vehicle seat for a motor vehicle comprising:
a backrest; and
the lumbar shield arrangement according to claim 1, the lumbar shield arrangement being arranged a seat frame of the backrest.

15. A motor vehicle comprising at least one vehicle seat according to claim 14.
